(19) United States
(12) Patent Application Publication
(10) Pub. No.: US 2010/0132236 A1
(43) Pub. Date: Jun. 3, 2010

(54) DISPLAY DEVICE FOR HANGING BANNER

(75) Inventor: Martin Ross Moulson Dibben, Hertfordshire (GB)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Ideas By Design Ltd., Hertfordshire (GB)

(21) Appl. No.: 12/595,020

(22) PCT Filed: Mar. 20, 2008
(86) PCT No.: PCT/GB2008/001091

§ 371 Date: Dec. 9, 2009

(30) Foreign Application Priority Data
Apr. 19, 2007 (GB) 0707526.0

(51) Int. Cl. G09F 17/00

(52) U.S. Cl. 40/606.01

(57) ABSTRACT

Banner support apparatus (25) comprising: a first part (40) for releasably retaining a banner (44), the first part having an elongate body with a groove (42) extending along its length, the groove being configured to receive and at least in part trap one end of a banner; a second part (30) for attachment to lifting apparatus, the second part having an elongate body, with the first and second parts having interfitting profiles (54, 56) for releasably coupling the first and second parts to each other; and a mechanism for resisting de-coupling of the first and second parts (40, 30) when the profiles (54, 56) are interfitted.

The present invention relates to a display device for hanging a banner or similar display item.

### BACKGROUND ART

It is known to suspend advertising and exhibition banners or the like from ceilings or other elevated positions. The banners may be displayed in shopping centres, supermarkets or other public locations where advertising space is at a premium.

An example of a known suspension device is described in WO2005/096253. The device comprises a housing, a drive shaft having a roller segment and a drive mechanism. At least one elongate tape is attached to the roller segment at one end with the other end free to attach to a banner. The drive mechanism drives rotation of the drive shaft and roller segment to extend or retract the tape(s) from or into the housing whereby a banner is raised or lowered. In one embodiment, the banner has a hem pocket at one end which receives a banner support rail. Clips which fit over the banner support rail are fastened to the banner to attach it to the tape(s). Another embodiment uses a banner support rail with a substantially C-shaped channel. The banner is slid into the C-shaped channel from one end of the rail.

Another known design is shown in FIGS. 1a to 1c. As with the previously described design the banner 10 has a hem pocket into which a tube is inserted. The hem (with inserted tube) is slid lengthwise into a hem bar 12 which is attached to a mounting bar 14 by at least one cable 22. The mounting bar 14 has rugged flanges 16 to enable it to be easily mounted to a ceiling or other elevated position. Inside the mounting bar 14 is a spiral groove drum 18 around which the cable is wound. A driving mechanism 20 is mounted within the drum 18 to wind the cable to lift or lower the banner 10. The drum is keyed positively so that the cable and hence the banner stays true as the banner is raised.

The present applicant has appreciated that there are certain disadvantages to the known systems. If a hem pocket is required to be securely formed at one end of the banner this adds an extra process to the production of a banner. Such a pocket needs to be stitched or welded and many banner manufacturers do not have the capability to sew or weld. Furthermore, sliding the banner support rail into the hem pocket or sliding the banner into the support rail from one end may be awkward, particularly for wide banners. If a banner is say 1500 mm wide, a clear space to one side, also of 1500 mm of the banner is required to manoeuvre the banner into position and slide the banner relative to the banner support rail. Such a system is not usable if space is restricted.

The present applicant has taken these disadvantages into consideration and provided a novel device which obviates or at least alleviates them.

### STATEMENT OF THE INVENTION

In accordance with the present invention, there is provided banner support apparatus comprising:

a first part for releasably retaining a banner, the first part having an elongate body with a groove extending along its length, the groove being configured to receive and at least in part trap one end of a banner;

a second part for attachment to lifting apparatus, the second part having an elongate body, with the first and second parts having interfitting profiles for releasably coupling the first and second parts to each other; and

a mechanism for resisting de-coupling of the first and second parts when the profiles are interfitted.

The groove may be configured to receive and retain an end of a banner which has been folded over and reinforced with a strip-like stiffener. The groove may have at least one flange extending from one side of the groove towards an opposing side thereof. The flange may define an opening which is narrower than the rest of the groove with the opening being large enough to receive an end of a banner which has been folded over and reinforced. The opening may extend lengthways along the length of the groove whereby the entire length of one end of banner may be inserted into the opening.

In contrast to some of the prior art, the banner is inserted into the first part rather than inserting the part into a hem pocket of the banner. Furthermore, in contrast to the second embodiment of WO2005/096253, the banner is not slid into the first part from one end. This allows the device to be used in confined spaces.

One part may comprise a crook-like form and the other part may comprise an arcuate form which is a snug and sliding fit within the crook-like form to provide a hinge-like action when the two parts are interfitted. In this way, the first and second parts may be releasably coupled by rotation relative to each other. This is one way of ensuring that the two parts are easily attached or detached when there is no load on the system but are not detachable when there is a load. One part may also comprise a stop to prevent the two parts being pulled apart when rotationally engaged.

The second part may be attached to the lifting mechanism by any known mechanism e.g. tapes or cables. However, cables are preferred, particularly 1.0 mm or 1.5 mm stainless steel cables, because at height, such cables are almost invisible and the banner appears to be floating. In contrast, tapes tend to have a minimum width of 10 mm and are thus very visible. Moreover, they may flap in air movement and may fold over during operation.

The second part may comprise a bar and a cover plate which are releasably secured together with a cable sandwiched therebetween. The bar may be attached to the cover plate by at least one bolt with a cable passing around the thread of the at least one bolt. The bar may be provided with a channel which is adapted to receive the head of the at least one bolt. A locking nut may be attached to the at least one bolt to secure the bar and the cover plate.

The bar and cover plate are preferably attached by at least two bolts whereby the second part is levelable, e.g. by loosening the bolts, sliding the second part to level and tightening the bolts. More cables and bolts may be used for wider or heavier banners.

The second part may be connected to any known drive mechanism, e.g. geared manual mechanism or an electric rotor mechanism as discussed above. The driving mechanism used to lift and lower the banner may be provided with radio and top torque stop so that if the banner encounters an obstruction as it is lifted, the driving mechanism will stop. The second part may be attached to any known mounting mechanism such as the one shown in FIG. 1b for mounting the device to a ceiling.

The first and second parts may be a snap fit, an interference fit or a friction fit on each other. For example, the first part may have a projection or stop which engages with a surface of the second part to provide an interference fit. In this way, the profiles of the first and second parts provide the mechanism for resisting de-coupling of the parts. Alternatively, or additionally, the mechanism for resisting de-coupling of the parts may be in the form of a locking mechanism.

The locking mechanism may also prevent a banner from sliding out of an end of the first part. The locking mechanism may be mounted on the second part, for example on the cover plate which may extend beyond the length of the second part. A locking mechanism may be mounted at each end.

The locking mechanism may comprise a locking bar which rotated from a first open position to a second locking position in which the locking bar prevents decoupling of the first and second parts. The locking bar may apply a positive bias to push the two parts together. A key may be used to rotate the locking bar and the locking mechanism may be adapted so that the key may not be removed from the lock until the locking bar is secured. It is thus clearly visible to any user whether or not the lock is secured. Furthermore, a key lock may be user many thousands of times without any detriment to its operation.

Both the first and second parts may be extruded and may have a constant cross-section. In this way, the manufacture of the banner support apparatus is simplified.

According to another aspect of the invention, there is provided a banner for use with a banner support apparatus as previously described. The end of the banner which is inserted into the first part may be reinforced, e.g. by a strip-like stiffener attached along the end. The banner may be folded over the stiffener before insertion into the first part. Such a stiffener, e.g. adhesive-backed plastic strip may easily be added after the banner is produced, either by the banner manufacturers or at the display site.

In contrast to the prior art, there is no welding or any other additional processing step. The banner may be rolled and shipped to the display site in a box. Once the reinforced end is inserted in the first part, the banner may be unrolled from the box.

### BRIEF DESCRIPTION OF THE DRAWINGS

An embodiment of the invention will now be described by way of example, with reference to the accompanying Figures in which:

FIG. 1a is a perspective view of a prior art banner support;

FIGS. 1b and 1c are perspective views of components of the support of FIG. 1a;

FIGS. 2a and 2b are cross-sectional views of components of a display device embodying the present invention;

FIGS. 3a to 3c are cross-sectional view showing the assembly of the components of FIGS. 2a and 2b to form a display device, and

FIGS. 4a and 4b are front and rear perspective views of one end of a banner display device according to the present invention.

### DETAILED DESCRIPTION OF THE DRAWINGS

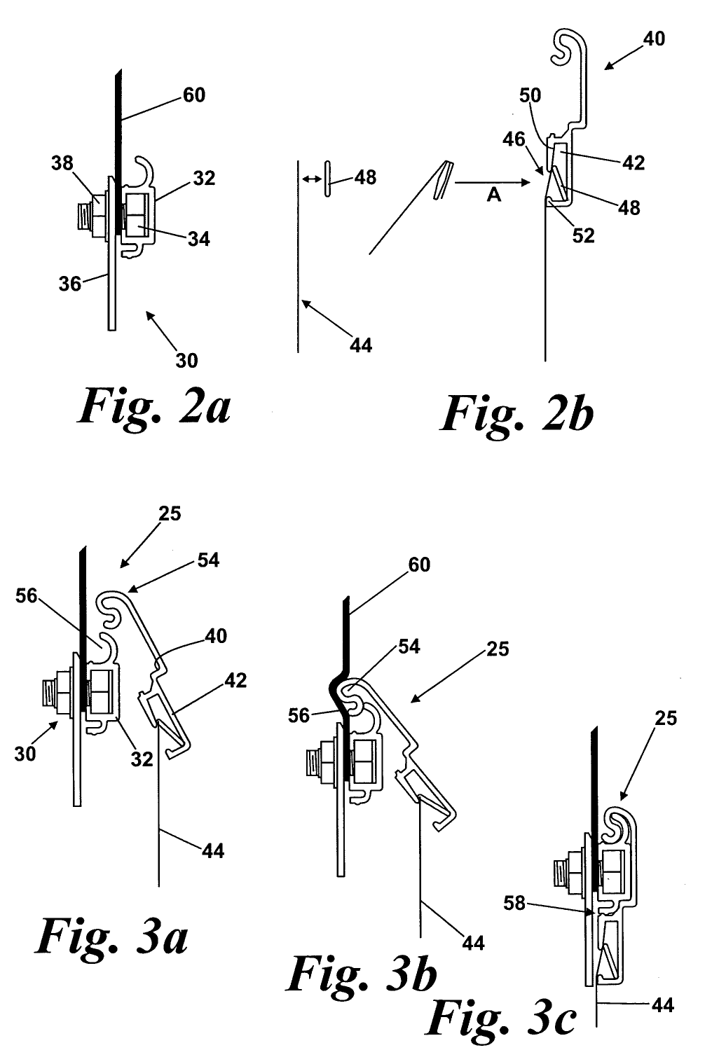

FIGS. 2a and 2b illustrate cross-sectional views of first and second parts of banner support apparatus 25 embodying the present invention. The first part is hereinafter referred to as the banner support member 40 and the second part is hereinafter referred to as the attachment member 30.

FIG. 2a shows the attachment member 30 which comprises a bar 32 having a channel running along its length and a cover plate 36 releasably attached to the bar 32. The channel is configured to receive the head 34 of at least one bolt (e.g. an M6 bolt head) and has a cross-section which is generally rectangular. The cover plate 36 comprises at least one aperture through which the thread of the bolt passes. A locking nut 38 secures the cover plate 36 to the bar 32.

Two lifting cables 60 are attached to the attachment member 30 by sliding the heads 34 of two bolts along the channel and looping one cable 60 under each bolt's shaft. As each cable is a loop, each cable may be slid around the respective bolt until the attachment member 30 is level. A minimum of two cables are required for a system which can be levelled, but more cables may be used for additional strength if required. Once it is level, the locking nuts 38 are tightened to secure the cables in position between the bar and its cover plate. The use of locking nuts prevents the cover plate from becoming separated from the bar in use.

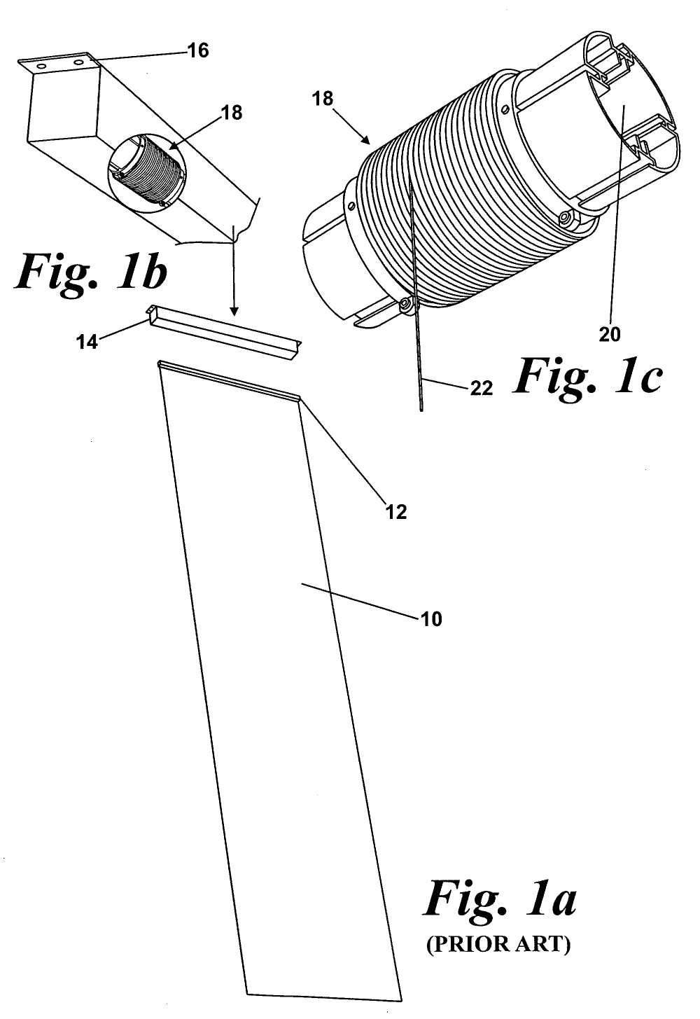

The lifting cable is preferably stainless steel and may be 1.0 or 1.5 mm in diameter. Such cables are nearly invisible when the banner is in position. The lifting cable is attached to a known mounting mechanism (not shown) such as the one shown in FIGS. 1a to 1c.

FIG. 2b shows the banner support member 40 comprising a groove or channel 42 which runs along the length of the banner support member and is configured for receiving a banner 44. The cross-section of the groove 42 is generally rectangular with a restricted opening in the form of a slot 46 running along the length of one wall of the channel 42. The slot is defined between upper and lower portions of the channel wall, with the upper portion larger than the lower portion 52 to ensure that the banner remains in the groove. The upper portion 50 is in the form of a flange.

The banner 44 is attached to the banner support member 40 by inserting one end of the banner 44 through the slot 46 in the direction of arrow A rather than by sliding the banner 44 through one axial end of and along the length of the groove 42. The end of the banner 44 which is inserted into the slot is reinforced by attaching a strip-like stiffener 48, e.g. adhesive-backed plastic strip, along its length and folding over the reinforced end. The stiffener 48 and groove 42 are configured such that the former must be angled to pass through the mouth of the latter. Once the reinforced end of the banner 44 is inserted in the groove 42, the stiffener 48 bears against an inner surface of the upper portion 50 of the groove wall, preventing the banner 44 from being removed from the groove 42 via the slot 46. The banner 42 may be removed by sliding it along the groove 42 and out of an open axial end. Alternatively, the banner 44 may be removed by reversing the insertion procedure, e.g. by pushing the banner 44 into the groove 42, holding the stiffening strip close to the banner at the bottom of the strip, and withdrawing the banner.

FIGS. 3a to 3c show how the banner support member 40 is attached to the attachment member 30. The banner support member 40 is formed with a crook-like form 54 running along its top which engages with an arcuate form in the shape of a channel 56 running along the top of the bar 32 of the attachment member. The crook-like form has a hook shaped cross-section. As shown in FIG. 3b, as the crook-like form 54 is pushed into the channel 56, the cable 60 is deflected. Once the crook-like form 54 is within the channel 56, the banner support member 40 is rotated about an axis running along the length of the channel until the banner support member 40 is clipped onto the attachment member as shown in FIG. 3c. A projection or stop 58 is provided on the lower side of the bar 30. The projection abuts the upper surface of the banner groove 42 to ensure that the banner support member is an interference fit on the attachment member.

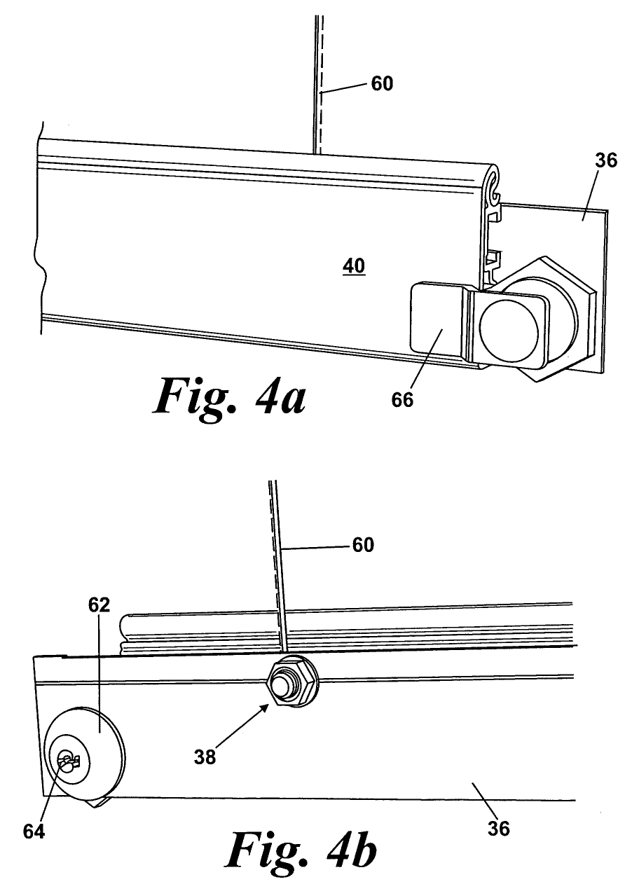

As shown in FIGS. 4a and 4b, the cover plate 36 of the attachment member 30 is longer than the banner support member 40. A locking mechanism 62 is mounted to each end of the cover plate 36 where it extends beyond the banner support member 40. The locking mechanisms 62 comprise a locking bar 66 which is rotatable from an open position in which the locking bar is perpendicular to the banner support member to a locked position in which it is parallel to and pressed against the banner support member. The 10 locking bar 66 is rotated by a key inserted into key hole 64. In the locked position, the banner support member 40 is securely fixed to the attachment member 30. Furthermore, the banner is prevented from sliding out of the ends of the banner support member 40.

1. Banner support apparatus comprising:
a first part for releasably retaining a banner, the first part having an elongate body with a groove extending along its length, the groove being configured to receive and at least in part trap one end of a banner;
a second part for attachment to lifting apparatus, the second part having an elongate body, with the first and second parts having interfitting profiles for releasably coupling the first and second parts to each other; and
a mechanism for resisting de-coupling of the first and second parts when the profiles are interfitted.

2. Apparatus according to claim 1, wherein the first and second parts are an interference fit on each other to form a mechanism for resisting de-coupling of the first and second parts.

3. Apparatus according to claim 1 or claim 2, wherein the first and second parts are releasably coupled by rotation relative to each other.

4. Apparatus according to any one of the preceding claims, wherein one part comprises a crook-like forma and the other part comprises an arcuate form which is a snug and sliding fit within the crook-like form to provide a hinge-like action when the two parts are coupled together.

5. Apparatus according to any one of the preceding claims, wherein the second part is attached to a lifting mechanism by at least one cable.

6. Apparatus according to claim 5, wherein the second part comprises a bar and a cover plate which are releasably secured together with the at least one cable sandwiched therebetween.

7. Apparatus according to claim 6, wherein the bar is attached to the cover plate by at least one bolt with a cable passing around the thread of the at least one bolt.

8. A device according to claim 7, wherein a locking nut is attached to the at least one bolt to secure the bar and the cover plate.

9. A device according to claim 7 or claim 8, wherein the second part is attached to a lifting mechanism by at least two cables passing around at least two bolts whereby the second part is levelable.

10. Apparatus according to any one of the preceding claims, wherein the mechanism for resisting de-coupling of the first and second parts comprises a locking mechanism.

11. Apparatus according to claim 10, comprising a locking mechanism at each end to prevent a banner from sliding out of an end of the first part.

12. Apparatus according to claim 10 or claim 11, wherein the locking mechanism comprises a locking bar which rotated from a first open position to a second locking position in which the locking bar resists de-coupling of the first and second parts.

13. Apparatus according to any one of claims 10 to 12, wherein the locking mechanism is operated by a key which is not removable from the lock until the lock is secured.

14. Apparatus according to any one of the preceding claims, wherein the groove comprises at least one flange extending from one side of the groove towards an opposing side thereof.

15. Apparatus according to claim 14, wherein the flange defines an opening which is narrower than the rest of the groove with the opening being large enough to receive an end of a banner.

16. Apparatus according to claim 14 or claim 15, wherein the opening extends along the length of the groove whereby the entire length of one end of a banner may be inserted into the opening.

17. A banner for use with apparatus as claimed in any preceding claim, wherein the end of the banner which is inserted into the first part is reinforced.

18. A banner according to claim 17, wherein the reinforcement is in the form of a strip-like stiffener attached along the end.
